(19) United States
(12) Patent Application Publication
(10) Pub. No.: US 2015/0199653 A1
(43) Pub. Date: Jul. 16, 2015

(54) LOCATION ADAPTIVE ELECTRONIC CALENDAR SYSTEM

(71) Applicant: Apple Inc., Cupertino, CA (US)

(72) Inventors: Gencer CILI, Santa Clara, CA (US); Devrim VAROGLU, Santa Clara, CA (US)

(73) Assignee: Apple Inc., Cupertino, CA (US)

(21) Appl. No.: 14/156,248

(22) Filed: Jan. 15, 2014

(51) Int. Cl. G06Q 10/10

(52) U.S. Cl. CPC G06Q 10/1095

(57) ABSTRACT

Disclosed herein is a technique for a location adaptive electronic calendar system. In particular, the location adaptive electronic calendar system is configured to dynamically analyze and track location information associated with users who utilize the location adaptive electronic calendar system. In turn, the location information associated with the users is compared against both proposed and scheduled meetings in order to provide various useful features and information to the user.

### FIELD

The described embodiments relate generally to software applications. More particularly, the present embodiments describe a technique for providing a location-adaptive electronic calendar system.

### BACKGROUND

Recent years have shown a proliferation in the use of software applications for managing personal schedules. This proliferation is occurring for a variety of reasons, which include both the widespread adoption of electronic devices and the ever-increasing complexity of schedules maintained by the average individual. Typical software applications used by an individual to manage his or her schedule—such as Apple's® native “Calendar” application—provide a set of features that help streamline the process for scheduling and managing meetings. These features can include, for example, the ability to schedule meetings through dictation of natural language (e.g., via Apple's® Siri®), and the ability to issue to one or more individuals an electronic invitation to attend a meeting. In turn, the Calendar application can provide useful information to the individual, including a snapshot view of a daily schedule and reminders for upcoming meetings.

Notably, while the foregoing feature set provides many benefits to the individual, considerable analysis on the individual's part continues to be required when scheduling and managing his or her meetings. For example, the individual is required to estimate and implement buffer times between meetings to account for various downtimes, e.g., travel time between two different meeting locations. As a result, meetings are often scheduled at times that cannot be met by the participants, which decreases overall efficiency and productivity. Moreover, when a particular time period (e.g., a day or a week) involves several meetings at different locations, the individual is imposed with the task of scheduling out where and when the meetings should occur. This is not only a complex task for the individual to carry out, but can also lead to producing a schedule that, in many cases, can otherwise be substantially optimized.

### SUMMARY

Representative embodiments set forth herein disclose various techniques for providing a location adaptive electronic calendar system.

One embodiment sets forth a method for implementing a location adaptive electronic calendar. The method includes the step of receiving information that defines particular aspects of a proposed meeting, where the information specifies an organizer and at least one invitee to attend the proposed meeting, and a duration and a location for the proposed meeting. The method further includes the step of identifying first current location information associated with the organizer and second current location information associated with the at least one invitee, and calculating a suggested meeting time for the proposed meeting based at least on the first current location information and the second current location information.

Another embodiment of the invention sets forth a non-transitory computer readable storage medium storing instructions that, when carried out by a processor included in a computing device, cause the computing device to carry out various steps. The steps can include receiving, from a user, a selection of a first location for a first meeting, and identifying at least one of a second meeting that precedes the first meeting and a third meeting that succeeds the first meeting, where each of the second meeting and the third meeting is associated with a second location and a third location, respectively. The steps can further include determining, based on the first location, and the at least one of the second location and the third location, a suggested time for the first meeting, and presenting the suggested time to the user.

Yet another embodiment of the invention sets forth a system for implementing a location adaptive electronic calendar. The system can include a processor and a memory, where the memory is configured to store instructions that, when executed by the processor, cause the system to receive information that defines particular aspects of a proposed meeting. The information can specify at least one invitee to attend the proposed meeting, and a location for the proposed meeting. The processor further causes the system to display a user interface that indicates available meeting times associated with the at least one invitee, where the available meeting times are based at least on the location for the proposed meeting.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of a system for implementing a location adaptive electronic calendar system, according to some embodiments.

FIGS. 2A-2B illustrate conceptual diagrams of user interface features for the location adaptive electronic calendar system described herein, according to some embodiments.

FIG. 3 illustrates a method for generating a proposed meeting that is location-adaptive and includes at least an organizer and one or more invitees, according to some embodiments.

FIG. 4 illustrates a conceptual diagram of user interfaces for displaying location-adaptive meeting availability times of one or more meeting invitees, according to some embodiments.

FIG. 5 illustrates a method for issuing update notifications to invitees of a meeting based on current location information associated with at least one of the invitees, according to some embodiments.

FIG. 6 illustrates a detailed view of a computing device that can be used to implement the various client devices and server devices described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described above, the embodiments described herein set forth a technique for providing a location adaptive electronic calendar system. In particular, the location adaptive electronic calendar system is configured to dynamically analyze and track location information associated with users who utilize the location adaptive electronic calendar system. In turn, the location information associated with the users is compared against both proposed and scheduled meetings in order to provide various useful features and information to the user, which are described below in greater detail.

According to one embodiment, the location adaptive electronic calendar system provides a user interface configured to display, for a particular time period of a schedule (e.g., a daily schedule) of a user, both a calendar view of the schedule as well as a map view of the schedule. The map view can include, for each meeting that is within the particular time period and specifies a location, an indicator that includes information about the meeting (e.g., a time for the meeting and a subject of the meeting). The map view can further include travel route information that links each of the meetings together chronologically and indicates optimal routes that can reduce overall travel time required for the user to attend the meetings. The travel route information can be periodically and dynamically updated by the location adaptive electronic calendar system and can be based on a wide range of data that includes, but is not limited to, map data for different travel method types (e.g., walking, cycling, public transportation, driving, etc.), existing and/or historical road traffic conditions, existing and/or historical weather conditions, and the like.

The calendar view can further provide a feature that suggests an optimal time for a new meeting based on a location on the map specified by the user (e.g., via a touch-based input, a mouse click, etc.). In turn, the location adaptive electronic calendar system calculates, based on times and locations of surrounding meetings of the user, an optimal start time and duration for the new meeting. The optimal start time and duration are presented to the user (e.g., via an indication positioned relative to the selected location within the calendar view), whereupon he or she can modify and/or confirm the new meeting. Moreover, the location adaptive electronic calendar system can notify the user about meeting slots that can potentially be switched, especially when switching the meeting slots results in an overall optimization of the user's schedule. For example, the location adaptive electronic calendar system can be aware of a user's home area and identify that switching the last two meetings of a particular day will reduce the day's overall commute time and position the user closer to his or her home area after the final meeting is completed.

According to another embodiment, the location adaptive electronic calendar system provides a user interface configured to receive, from a meeting organizer, information for a new meeting, and, in response, to dynamically display available meeting times for at least one invitee specified by the information for the new meeting. More specifically, the available meeting times are determined by the location adaptive electronic calendar system based on various components that include a time, a duration, and a location of the new meeting, previous and/or next meeting time(s), duration(s), and location(s) of the at least one invitee relative to the new meeting, current location information associated with the at least one invitee, and the like. The available meeting times are dynamically updated and displayed in response to changes to the foregoing components. For example, if an originally-specified location of the new meeting is updated to a new location, and the location adaptive electronic calendar system determines that it will take the at least one invitee an additional forty five minutes to travel to the new location, then the available meeting times of the at least one invitee are accordingly narrowed within the user interface.

In addition, the location adaptive electronic calendar system enables each user to specify various preferences that dictate how the location adaptive electronic calendar system manages his or her data. More specifically, each user can specify the level of granularity at which his or her location information is used by the location adaptive electronic calendar system. For example, a user can restrict his or her current location information from being used by the location adaptive electronic calendar system, but allow the location adaptive electronic calendar system to access location information associated with his or meetings in order to utilize a subset of the beneficial features provided by the location adaptive electronic calendar system. In another example, a user can indicate particular meetings that are inflexible in order to prevent the location adaptive electronic calendar system from issuing suggestions that are irrelevant, thereby enhancing the user's overall experience.

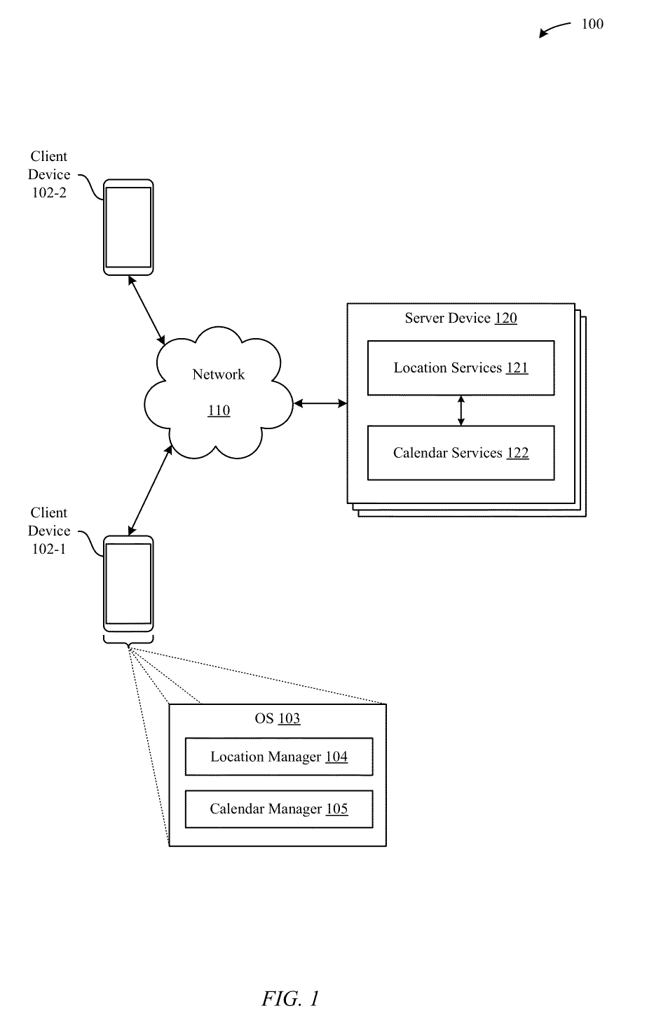

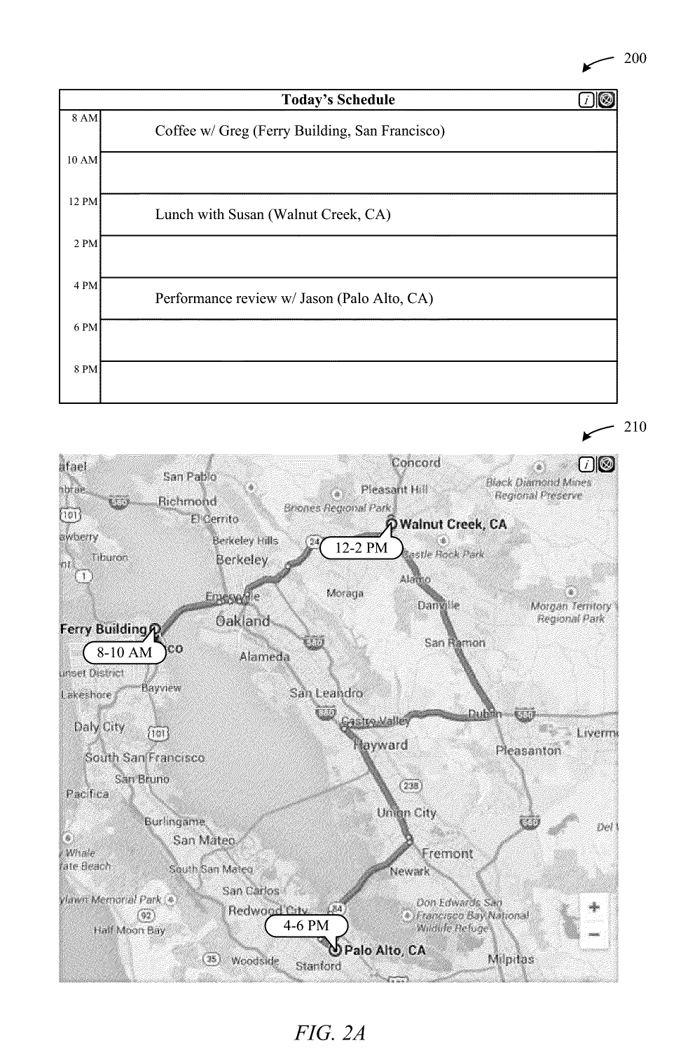

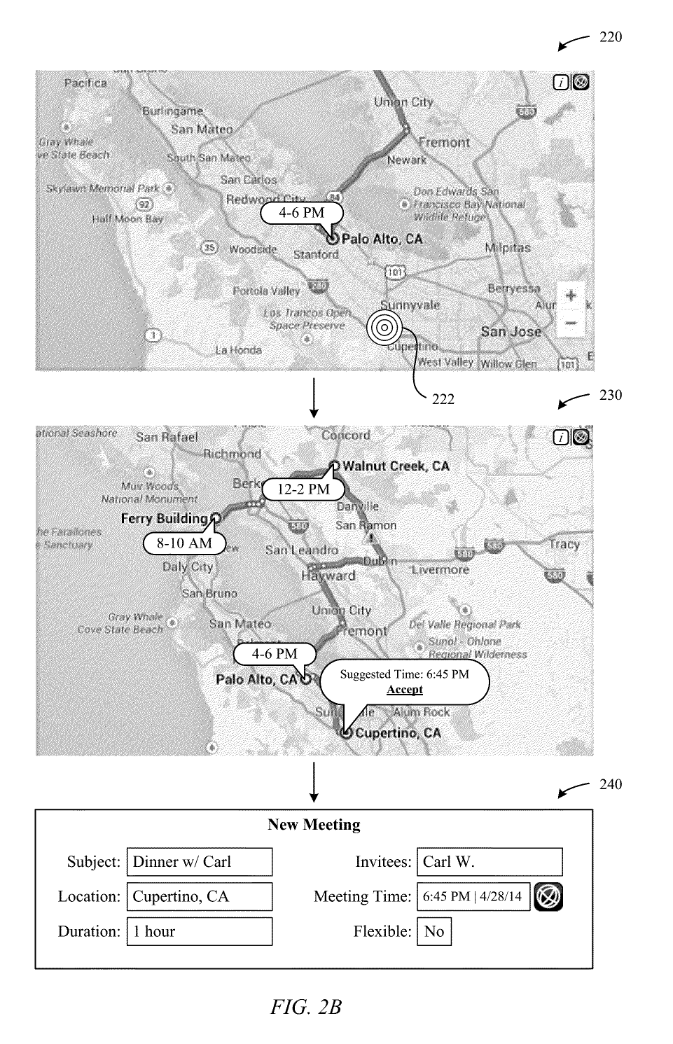

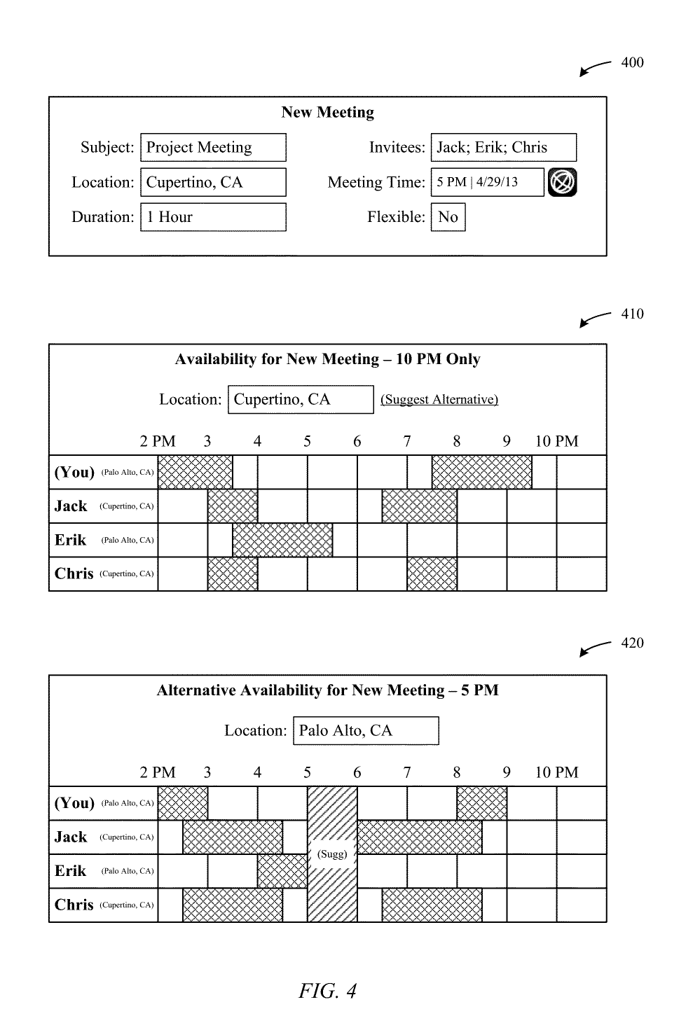

FIG. 1 illustrates a block diagram of a system 100 configured to implement various representative embodiments. More specifically, FIG. 1 illustrates a high-level overview of the system 100, which, as shown, includes client devices 102-1 and 102-2, which each are configured to execute an operating system (OS) 103 (e.g., Apple® iOS®). As also shown in FIG. 1, the OS 103 on the client device 102-1 is configured to execute a location manager 104 and a calendar manager 105. According to one embodiment, the location manager 104 is a software component that can identify (e.g., via hardware components included in the client device 102-1) a location of the client device 102-1 according to well-known techniques. For example, these techniques can include, but are not limited to, global positioning system (GPS) techniques, WiFi-based location techniques, and the like. As described in greater detail below, the location manager 104 is utilized by the calendar manager 105, and the calendar manager 105 is configured to provide the various user interfaces described herein and illustrated in FIGS. 2A-2B and 4.

Also shown in FIG. 1 are a plurality of server devices 120, which, as shown, are each configured to implement location services 121 and calendar services 122. As described below in greater detail, location services 121 is configured to periodically receive up-to-date location information from location managers 104 executing on the client devices 102. Similarly, calendar services 122 are configured to receive calendar data (e.g., meeting information) from calendar managers 105 and to manage the calendar data according to the techniques described herein. In particular, location services 121 and calendar services 122 are configured to work in conjunction in order to implement the various aspects of the location adaptive electronic calendar system described herein. It is noted, however, that the client/server architecture illustrated in FIG. 1 is not required to implement this system. For example, the embodiments described herein can also be implemented using a peer-to-peer approach, which would involve various client devices 102 sharing location and calendar data with one another to achieve the same functionality.

FIGS. 2A-2B illustrate conceptual diagrams of user interface features for the location adaptive electronic calendar system described herein, according to some embodiments. In particular, FIG. 2A includes an exemplary snapshot 200 of the calendar view described above, which is generated by the calendar manager 105. As shown, the exemplary snapshot 200 includes a listing of a user's daily schedule, which includes three meetings that have been scheduled to occur in different locations. FIG. 2A also includes an exemplary snapshot 210 of the map view described above, which is also generated by the calendar manager 105. A user can toggle between the calendar view and the map view by, for example, selecting the toggle icons that are depicted in both the exemplary snapshot 200 and the exemplary snapshot 210. As shown in FIG. 2A, the exemplary snapshot 210 correlates to the listing of the user's daily schedule, and includes, for each of the three meetings, an indicator that includes time-based information about the meeting. As also shown in FIG. 2A, the exemplary snapshot 210 includes travel route information that links each of the meetings together chronologically and indicates optimal routes as suggestions for the user to take in order to attend the meetings. As previously noted above, the travel route information can be periodically and dynamically updated by the location adaptive electronic calendar system and can based on a wide range of data that includes, but is not limited to, map data for different travel method types (e.g., walking, cycling, public transportation, driving, etc.), existing and/or historical traffic conditions, existing and/or historical weather conditions, and the like.

As previously noted above, the calendar view can further provide a feature that suggests an optimal time for a new meeting based on a location on the map specified by the user (e.g., via a touch-based input). FIG. 2B illustrates this feature through exemplary snapshots 220, 230 of the map view and exemplary snapshot 240 of the calendar view. In particular, the exemplary snapshot 220 is an extension of the exemplary snapshot 210 shown in FIG. 2A, where a meeting at 4:00 PM in Palo Alto, Calif., is a final meeting for the day. According to the example illustrated in FIG. 2B, a touch-based input 222 is received at a point on the map that represents Cupertino, Calif. In response, the calendar manager 105, in conjunction with one or more of the server devices 120, calculates, based on times and locations of surrounding meetings of the user (e.g., the 4:00 PM meeting in Palo Alto), an optimal start time and duration for the new meeting. The optimal start time is presented to the user (e.g., via an indication positioned relative to the selected location within the calendar view), which is illustrated in the exemplary snapshot 230. The user can modify and/or confirm the new meeting by, e.g., selecting “Accept” via another touch-based input, which causes the calendar manager 105 to display a user interface (depicted by exemplary snapshot 240) that enables the user to enter in additional parameters of the meeting (e.g., a subject, a duration, invitees, and whether the meeting is flexible).

Although not illustrated in FIGS. 2A-2B, the calendar manager 105 can further be configured to notify the user about meeting slots that can potentially be switched, especially when switching the meeting slots results in an overall optimization of the user's schedule. For example, the location adaptive electronic calendar system can be aware that the user's home area is Palo Alto, Calif., and identify that switching the meeting in Palo Alto, Calif. with the meeting in Cupertino, Calif. will reduce the day's overall commute time and position the user closer to his or her home area after the final meeting is completed.

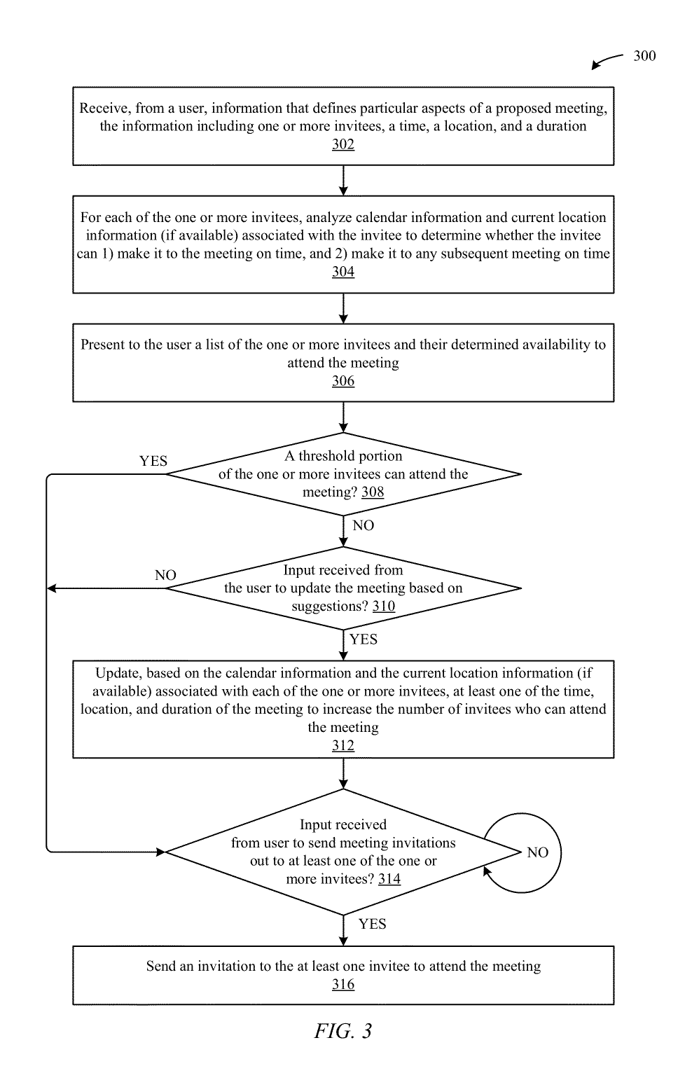

FIG. 3 illustrates a method for generating a proposed meeting that is location-adaptive and includes at least an organizer and one or more invitees, according to some embodiments. As shown, the method 300 begins at step 302, where at least one of the server devices 120 receives, from a user, information that defines particular aspects of a proposed meeting, the information including one or more invitees, a time, a location, and a duration. According to one embodiment, the user inputs meeting parameters into the calendar manager 105 on a client device 102, whereupon the calendar manager 105, in conjunction with the location manager 104, provides the information to the server device 120 for processing.

At step 304, the server device 120, for each of the one or more invitees, analyzes calendar information and current location information (if available) associated with the invitee to determine whether the invitee can 1) make it to the meeting on time, and 2) make it to any subsequent meeting on time. At step 306, the server device 120 presents to the user a list of the one or more invitees and their determined availability to attend the meeting. An example of this presentation is illustrated in FIG. 4, which is described below in greater detail. At step 308, the server device 120 determines whether a threshold portion (e.g., 50% or more) of the one or more invitees can attend the meeting. If, at step 308, the server device 120 determines that the threshold portion of the one or more invitees can attend the meeting, then the method 300 proceeds to step 314, which is described below in greater detail. Otherwise, the method 300 proceeds to step 310.

At step 310, the server device 120 determines whether input is received from the user to update the meeting based on suggestions. More specifically, this input can be received from the user in response to prompting the user if he or she would like the server device 120 to assist the user in establishing a meeting that is more practical for the one or more invitees. If, at step 310, the server device 120 determines that input is received from the user to update the meeting based on suggestions made by the server device 120, then the method 300 proceeds to step 312. Otherwise, the method 300 proceeds to step 314.

At step 312, the server device 120 updates, based on the calendar information and the current location information (if available) associated with each of the one or more invitees, at least one of the time, location, and duration of the meeting to cause an increase the number of invitees who can attend the meeting. This can be carried out according to a variety of techniques, such as sequentially adjusting various parameters of the meeting to increase the number of invitees who are eligible to attend the meeting. This can involve, for example, updating the meeting location to an area that is more convenient for the invitees, updating the meeting time and/or duration, and, in some cases, suggesting the removal of particular invitees—especially those who have full schedules and likely cannot attend the meeting regardless of the adjustments that are made.

At step 314, the server device 120 determines whether input is received from the user to send meeting invitations out to at least one of the one or more invitees. If, at step 314, the server device 120 determines that input is received from the user to send meeting invitations out to at least one of the one or more invitees, then the method 300 proceeds to step 316, where the server device 120 sends an invitation to the at least one invitee to attend the meeting. Otherwise, the server device 120 waits at step 314 for the user to make a decision (e.g., accept, update, or cancel the meeting).

FIG. 4 illustrates a conceptual diagram of user interfaces for displaying location-adaptive meeting availability times of one or more meeting invitees, according to some embodiments. As previously mentioned above, the calendar manager 105 can be configured to receive, from a meeting organizer, information for a new meeting, which is illustrated by the exemplary snapshot 400 shown in FIG. 4. In response, the calendar manager 105 dynamically displays available meeting times for invitees specified by the user—which, as shown in the exemplary snapshot 410, includes three invitees in addition to the organizer The available meeting times of the three invitees are determined by the calendar manager 105 based on various components that include a time, a duration, and a location of the new meeting (as specified by the organizer), previous and/or next meeting time(s), duration(s), and location(s) of each invitee relative to the new meeting, current location information associated with each invitee, and the like. Notably, the available meeting times for each of the invitees are dynamically updated and displayed in response to changes to the foregoing components. This is shown by the exemplary snapshot 420, where the location of the meeting has switched from Cupertino, Calif. to Palo Alto, Calif. In particular, the calendar manager 105 determines that it will increase the available times for those who reside in Palo Alto, Calif. (i.e., the meeting organizer, and Erik) since little to no travel time is required, and that it will decrease the available times for those who reside in Cupertino, Calif. (Jack and Chris), since travel time is now required.

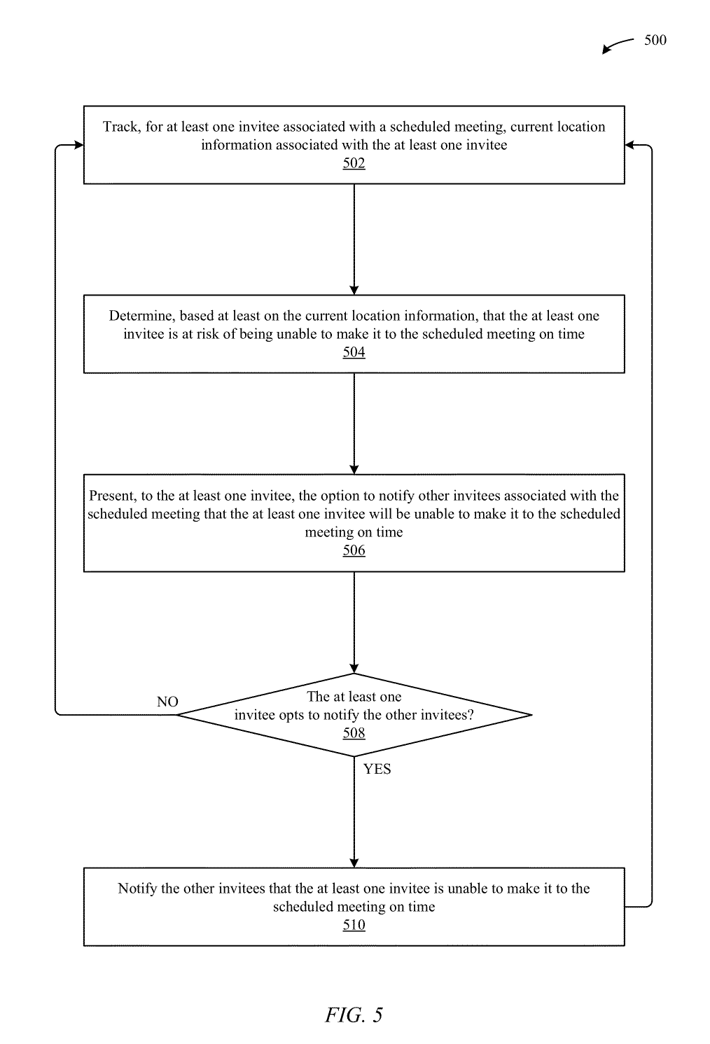

FIG. 5 illustrates a method for issuing update notifications to invitees of a meeting based on current location information associated with at least one of the invitees, according to some embodiments. As shown, the method 500 begins at step 502, where at least one of the server devices 120 tracks, for at least one invitee associated with a scheduled meeting, current location information associated with the at least one invitee.

At step 504, the server device 120 determines, based at least on the current location information associated with the at least one invitee, that the at least one invitee is at risk of being unable to make it to the scheduled meeting on time. At step 506, the server device 120 presents, to the at least one invitee, the option to notify other invitees associated with the scheduled meeting that the at least one invitee will be unable to make it to the scheduled meeting on time. At step 508, the server device 120 determines whether the at least one invitee opts to notify the other invitees. If, at step 508, the server device 120 determines that the at least one invitee opts to notify the other invitees, then the method 500 proceeds to step 510, where the server device 120 notifies the other invitees that the at least one invitee is unable to make it to the scheduled meeting on time. Otherwise, the method 500 proceeds back to step 502, and repeats.

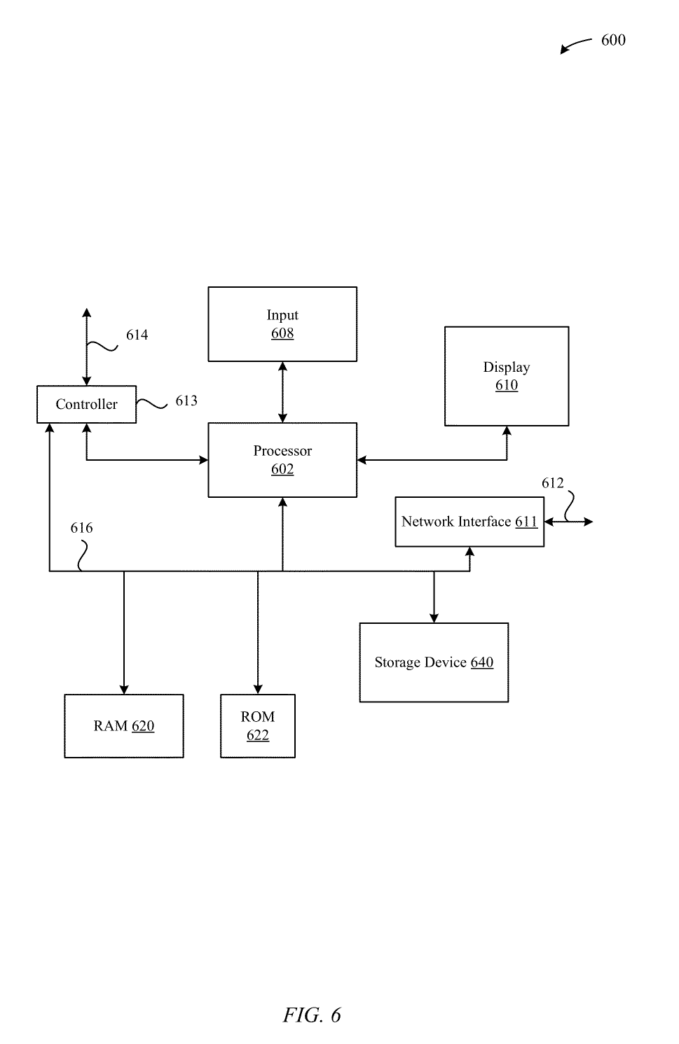

FIG. 6 is a block diagram of a computing device 600 that can represent the components of both the client devices 102 and the server devices 120. As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 (screen display) that can be controlled by the processor 602 to display information to the user. A data bus 616 can facilitate data transfer between at least a storage device 640, the processor 602, and a controller 613. The controller 613 can be used to interface with and control different equipment through and equipment control bus 614. The computing device 600 can also include a network/bus interface 611 that couples to a data link 612. In the case of a wireless connection, the network/bus interface 611 can include a wireless transceiver.

The computing device 600 also include a storage device 640, which can comprise a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random Access Memory (RAM) 620 and a Read-Only Memory (ROM) 622. The ROM 622 can store programs, utilities or processes to be executed in a non-volatile manner. The RAM 620 can provide volatile data storage, and stores instructions related to the components of the client devices 102 and the server devices 120 configured to carry out the various techniques described herein.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for implementing a location adaptive electronic calendar, the method comprising:
receiving information that defines particular aspects of a proposed meeting, wherein the information specifies:
an organizer and at least one invitee to attend the proposed meeting, and
a duration and a location for the proposed meeting;
identifying first current location information associated with the organizer and second current location information associated with the at least one invitee; and
calculating a suggested meeting time for the proposed meeting based at least on the first current location information and the second current location information.

2. The method of claim 1, wherein the information is received from by a client device that transmits the information in response to a user input.

3. The method of claim 1, wherein calculating the suggested meeting time for the proposed meeting is further based on additional meetings associated with the organizer and/or the at least one invitee that precede and/or succeed the proposed meeting.

4. The method of claim 1, wherein calculating the suggested meeting time for the proposed meeting is further based on road traffic conditions that influence an amount of time that is required for the organizer and/or the at least one invitee to travel to the location.

5. The method of claim 4, wherein calculating the suggested meeting time for the proposed meeting is further based on weather conditions that influence the amount of time that is required for the organizer and/or the at least one invitee to travel to the location.

6. The method of claim 1, further comprising:
receiving a request to generate a second suggested meeting time for the proposed meeting; and
calculating the second suggested meeting time for the proposed meeting that is different from the suggested meeting time for the proposed meeting.

7. The method of claim 6, wherein the request specifies one or more of an updated location and an updated duration for the proposed meeting.

8. The method of claim 1, further comprising:
receiving a confirmation for the proposed meeting; and
transitioning the proposed meeting into a scheduled meeting.

9. The method of claim 8, further comprising:
tracking, for the at least one invitee, current location information associated with the at least one invitee;
determine, based at least on the current location information, that the at least one invitee is unable to make it to the scheduled meeting on time; and
present, to the at least one invitee, an option to notify the organizer that the at least one invitee will be unable to make it to the scheduled meeting on time.

10. A non-transitory computer readable storage medium storing instructions that, when carried out by a processor included in a computing device, cause the computing device to:
receive, from a user, a selection of a first location for a first meeting;
identifying at least one of a second meeting that precedes the first meeting and a third meeting that succeeds the first meeting, wherein the second meeting and the third meeting are associated with a second location and a third location, respectively;
determining, based on the first location, and the at least one of the second location and the third location, a suggested time for the first meeting; and
presenting the suggested time to the user.

11. The non-transitory computer readable storage medium of claim 10, wherein the step of determining is further based on an end time associated with the second meeting and a start time associated with the third meeting.

12. The non-transitory computer readable storage medium of claim 10, wherein the step of determining is further based on road traffic conditions that influence an amount of time that is required for the user to travel from the first location to the second location and/or from the second location to the third location.

13. The non-transitory computer readable storage medium of claim 10, wherein the step of determining is further based on weather conditions that influence an amount of time that is required for the user to travel from the first location to the second location and/or from the second location to the third location.

14. The non-transitory computer readable storage medium of claim 10, further comprising receiving, from the user, an acceptance of the suggested time.

15. The non-transitory computer readable storage medium of claim 10, wherein the selection of the first location is received as a touch-based input.

16. A system for implementing a location adaptive electronic calendar, comprising:
a processor; and
a memory configured to store instructions that, when executed by the processor, cause the system to:
receive information that defines particular aspects of a proposed meeting, wherein the information specifies:
at least one invitee to attend the proposed meeting, and
a location for the proposed meeting;
display a user interface that indicates available meeting times associated with the at least one invitee, wherein the available meeting times are based at least on the location for the proposed meeting.

17. The system of claim 16, wherein the available meeting times are further based on road traffic conditions that influence an amount of time that is required for the at least one invitee to travel to the location.

18. The system of claim 16, wherein the available meeting times are further based on weather conditions that influence and amount of time that is required for the at least one invitee to travel to the location.

19. The system of claim 16, wherein the processor is further configure to update the available meeting times in response to changes made to components of the proposed meeting.

20. The system of claim 19, wherein the components include the location of the proposed meeting, as well as a start time, an end time, a date, a duration, and an indication that represents if the proposed meeting is flexible.
